(19) United States
(12) Patent Application Publication
(10) Pub. No.: US 2016/0056655 A1
(43) Pub. Date: Feb. 25, 2016

(54) BATTERY PACK FOR MOTOR-DRIVEN APPLIANCE

(71) Applicant: MAKITA CORPORATION, Anjo-shi (JP)

(72) Inventors: Junya KANEDA, Anjo-shi (JP); Masafumi NODA, Anjo-shi (JP)

(21) Appl. No.: 14/816,348

(22) Filed: Aug. 3, 2015

(30) Foreign Application Priority Data
Aug. 22, 2014 (JP) 2014-169568

(51) Int. Cl. H02J 7/00

(52) U.S. Cl. CPC H02J 7/0063; H02J 2007/0067

(57) ABSTRACT

A battery pack for a motor-driven appliance comprises a battery including a plurality of cells, a cell discharge unit that discharges each cell individually, a voltage detection unit that detects each cell voltage, a target cell determination unit, and a discharge control unit. When at least one cell having the cell voltage equal to or smaller than a specified threshold is present, the cell voltage that is the smallest among them is set as a smallest cell voltage, and when at least one other cell having the cell voltage larger than the smallest cell voltage by a defined value or more or having the cell voltage larger than the threshold by the defined value or more is present, the target cell determination unit determines the at least one cell as a target cell, and the discharge control unit causes the target cell to be discharged by the cell discharge unit.

### CROSS-REFERENCE TO RELATED APPLICATIONS

This application claims the benefit of Japanese Patent Application No. 2014-169568 filed Aug. 22, 2014 in the Japan Patent Office, the entire contents of which are incorporated herein by reference.

### BACKGROUND

The present invention relates to a battery pack for a motor-driven appliance including a battery configured with a plurality of chargeable and dischargeable cells connected in series to each other.

In the battery pack for a motor-driven appliance of this kind, there is a problem that, if the battery is used to become an over-discharged state repeatedly, unbalance in power progresses among the cells forming the battery and a life span of the battery is thereby shortened.

To cope with such a problem, a technique has been proposed in which a voltage of each cell (hereinafter referred to as “cell voltage”) is measured, the smallest value of the cell voltage (hereinafter referred to as “smallest cell voltage”) is obtained from respective measurements, and balancing is performed of a cell having a cell voltage whose voltage difference from the smallest cell voltage is equal to or larger than a defined voltage. Balancing is a process in which the cell to be balanced is discharged to thereby reduce charging power of the cell and variation in cell voltage among the respective cells is thereby reduced (see, for example, JP2013-081315).

### SUMMARY

In the technique set forth in JP2013-081315, each cell voltage is measured at the point when the battery pack is attached to the charger. The thus-measured voltage is a voltage in a state in which no current is supplied from each cell to a load, i.e., an open voltage. That is, in the technique set forth in JP2013-081315, an open voltage of each cell is measured, and the cell to be balanced is determined on the basis of the open voltage.

Since the open voltage of the cell is a voltage at no load (at no current application), an internal impedance of the cell is not reflected. Thus, depending on a state of the internal impedance of the cell, the cell that is intrinsically not required to be balanced may be determined as a balancing target and may be balanced needlessly. In contrast, the cell that is intrinsically required to be balanced may be determined as no target of balancing and may not be balanced.

For example, in a case of the cell having a high internal impedance, although the cell voltage thereof is larger than the cell voltages of the other cells in an opened state, the cell voltage is dropped significantly at discharge due to influence of the internal impedance and becomes smaller than the cell voltages of the other cells in some cases. If such a cell is determined as a balancing target on the basis of the open voltage and the power is reduced by balancing, the cell voltage at discharge drops more and the voltage difference from the cell voltages of the other normal cells may become larger.

In contrast, in a case of the cell having a low internal impedance, the cell voltage difference between in an opened state and at discharge is small, and thus, even when the cell contains more power than the other cells, the cell may not be determined as a balancing target because the voltage is smaller than those of the other cells in an opened state, and the difference in power from the other cells containing less power may thereby not be able to be reduced.

In the battery pack for a motor-driven appliance having a balancing function for reducing variation of the voltages of the plurality of cells forming the battery, it is one aspect of the present invention to enable an appropriate determination, when determining the cell to be balanced, with the internal impedance of each cell taken into account.

A battery pack for a motor-driven appliance according to one aspect of the present invention comprises a battery, a cell discharge unit, a voltage detection unit, a target cell determination unit, and a discharge control unit.

The battery is configured with a plurality of cells, which are chargeable and dischargeable, connected in series to each other. The cell discharge unit is configured to discharge each of the plurality of cells individually. The voltage detection unit is configured to detect a cell voltage, which is a voltage of each of the plurality of cells, when a driving power for a motor-driven appliance is supplied from the battery to the motor-driven appliance. The target cell determination unit is configured to make a determination of a target cell that should be discharged in order to reduce variation of the respective cell voltages when at least one cell, among the plurality of cells, having the cell voltage, detected by the voltage detection unit, equal to or smaller than a specified threshold is present. Specifically, the cell voltage that is the smallest among the cell voltages equal to or smaller than the threshold is set as a smallest cell voltage, and when at least one other cell having the cell voltage larger than the smallest cell voltage by a defined value or more or having the cell voltage larger than the threshold by the defined value or more is present, the at least one other cell is determined as the target cell. The discharge control unit is configured to cause the cell determined as the target cell by the target cell determination unit to be discharged by the cell discharge unit.

In the thus-configured battery pack for a motor-driven appliance, when supply of the driving power to the motor-driven appliance is performed, i.e., when discharge necessary for operation of the motor-driven appliance is performed from the battery to the motor-driven appliance, the determination of the cell to be discharged (balanced) by the cell discharge unit is made on the basis of the respective cell voltages at that time. Each cell voltage detected when the driving power is supplied is a value with the internal impedance of the corresponding cell taken into account. Thus, even if open voltages are relatively very high, the cell whose cell voltage is dropped at discharge to the motor-driven appliance due to its high internal impedance, i.e., the cell not required to be balanced, is inhibited from being determined as the target cell.

Consequently, with the battery pack for a motor-driven appliance configured as above, an appropriate determination can be made with the internal impedance of each cell taken into account, when determining the balancing target cell.

The battery pack for a motor-driven appliance may comprise a temperature detection unit that detects a temperature of the battery. In that case, the voltage detection unit may detect the cell voltage of each of the plurality of cells when the temperature of the battery detected by the temperature detection unit is within a defined temperature range.

Generally, the lower the temperature of the battery is, the larger the internal impedance of the battery is. Thus, the target cell may not be determined appropriately by the cell voltages at low temperature. Thus, the defined temperature range within which the cell voltages can be detected appropriately is set in advance, and the respective cell voltages are designed to be detected when the battery temperature is within the defined temperature range, to thereby enable more appropriate determination of the target cell.

The battery pack for a motor-driven appliance may comprise a storage unit in which information is storable, and when at least one cell determined as the target cell is present, the target cell determination unit may store the at least one target cell in the storage unit. The discharge control unit may cause the at least one target cell stored in the storage unit to be discharged by the cell discharge unit.

In this way, discharge of the target cell can be performed reliably by storing the target cell in the storage unit and discharging the target cell on the basis of the storage content of the storage unit.

When at least one cell determined as the target cell is present, the target cell determination unit may calculate a parameter indicating an order of priority of discharge to be performed by the discharge control unit for each target cell, and may store the parameter in the storage unit for each target cell.

By calculating and storing the parameter, in a case where there is more than one target cell, it is possible to determine appropriately and easily from which target cell the discharge should be performed, to thereby enable the discharge to be performed in an appropriate order.

It can be conceived variously what kind of value is specifically calculated by the target cell determination unit as the parameter for each target cell. For example, the target cell determination unit may calculate, as the parameter, a first variation data indicating a value obtained by subtracting the smallest cell voltage from the cell voltage of the target cell, or a second variation data indicating a value obtained by subtracting the threshold from the cell voltage of the target cell, and may store the first variation data or the second variation data in the storage unit.

For both of the first variation data and the second variation data, it is preferable that the larger the value thereof is, the higher priority the cell is given in terms of discharge. Thus, by calculating and storing the first variation data or the second variation data as the parameter, the order of discharge can be determined easily and appropriately. In addition, it is only necessary to perform a simple process, i.e., calculation and storage of either of the first variation data or the second variation data, and thus, it is possible to reduce influence on other various processes performed in the battery pack.

It is to be noted that the larger the cell voltage of the target cell is, the larger the value of each variation data is. Thus, when the target cell is balanced, in addition to the order of balancing determined on the basis of the parameter, a duration in which balancing is performed (i.e., discharge duration, and thus, discharge amount) may be set as appropriate for each target cell according to the parameter.

Alternatively, for example, the target cell determination unit may calculate, as the parameter, a rank, in descending order, of the value obtained by subtracting the smallest cell voltage from the cell voltage of the target cell, or a rank, in descending order, of the value obtained by subtracting the threshold from the cell voltage of the target cell, and may store the calculated rank in the storage unit. That is, substantially, the rank of the first variation data in descending order or the rank of the second variation data in descending order is stored as the parameter. In this way, by calculating and storing the rank as the parameter, the order of balancing to be performed later can be determined more easily.

The discharge control unit may cause the target cell to be discharged by the cell discharge unit when the battery has not been charged for a specified period of time set in advance or longer and also supply of the driving power to the motor-driven appliance has not been performed for the specified period of time or longer.

While the target cell is being balanced, the respective cell voltages (especially, the cell voltage of the target cell under balancing) may not be able to be measured accurately. Thus, if charging of the battery is controlled or discharge to the motor-driven appliance is controlled on the basis of the respective cell voltages while the balancing is being performed, various controls as these may not be performed properly. Thus, by performing the balancing when charging and supply of the driving power to the motor-driven appliance have not been performed for the specified period of time or longer, it is possible to reduce influence on various regular processes, such as control of charging of the battery and control of discharge to the motor-driven appliance.

Depending on an amount of charging power and/or the internal impedance of the cell, the target cell may not be determined in a state in which the driving power is being supplied to the motor-driven appliance. In that case, it may be possible not to perform balancing for the reason that no cell is present that needs to be balanced. However, in a case where a difference in open voltage is large, it may be preferable to perform balancing depending on the magnitude of the difference.

Thus, the battery pack for a motor-driven appliance may comprise a no-load-time determination unit configured to determine the target cell on the basis of the open voltages of the respective cells. When no target cell is determined as a result of determination by the target cell determination unit, the no-load-time determination unit may determine the necessity of balancing on the basis of the open voltages. Specifically, the no-load-time determination unit may detect the respective cell voltages at a specified determination timing during a period in which supply of the driving power from the battery to the motor-driven appliance is not performed, and may determine whether the cell to be discharged in order to reduce variation of the respective cell voltages is present on the basis of the detected respective cell voltages. Then, when it is determined that the cell to be discharged is present by the no-load-time determination unit, the discharge control unit may cause the cell to be discharged (balanced) as the target cell by the cell discharge unit.

As above, it is fundamental to detect the respective cell voltages during discharge to the motor-driven appliance to thereby determine presence/absence of the target cell, and if no target cell is present, presence/absence of the target cell is determined on the basis of the open voltages of the respective cells. The target cell that should be balanced can thereby be determined more appropriately.

### BRIEF DESCRIPTION OF THE DRAWINGS

The present invention will now be described by way of example with reference to the accompanying drawings, in which:

FIG. 1 is a block diagram showing a circuit configuration of a battery pack for a motor-driven appliance according to an embodiment and a charger;

FIG. 2 is a block diagram showing a circuit configuration of the battery pack for a motor-driven appliance according to the embodiment and a tool body;

FIG. 3 is a flowchart of a main process performed in the battery pack for a motor-driven appliance;

FIG. 4 is a flowchart of a discharge-time target cell determination process in the main process in FIG. 3;

FIG. 5A is a flowchart of a parameter calculation process in the discharge-time target cell determination process in FIG. 4, FIG. 5B is a flowchart of a parameter calculation process in a pre-charging target cell determination process in FIG. 6, and FIG. 5C is a flowchart of a parameter calculation process in a discharge-time target cell determination process in FIG. 8;

FIG. 6 is a flowchart of the pre-charging target cell determination process in the main process in FIG. 3;

FIG. 7 is a flowchart of a balancing process in the main process in FIG. 3; and

FIG. 8 is a flowchart showing another example of the discharge-time target cell determination process.

### DETAILED DESCRIPTION OF THE PREFERRED EMBODIMENTS

### (1) Configuration of Battery Pack 1

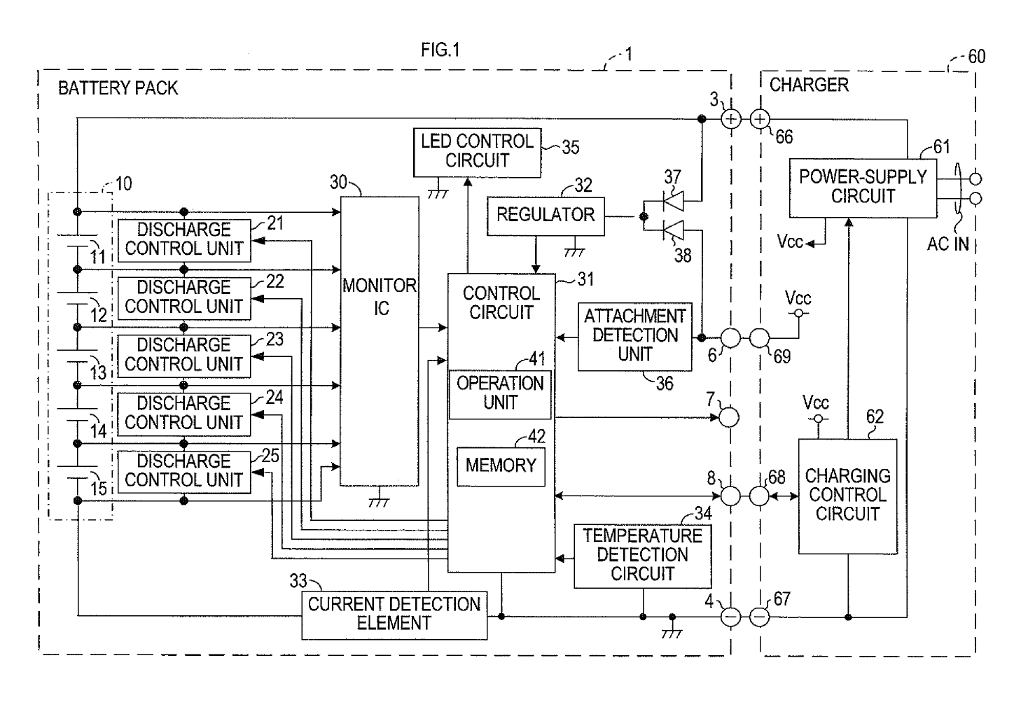

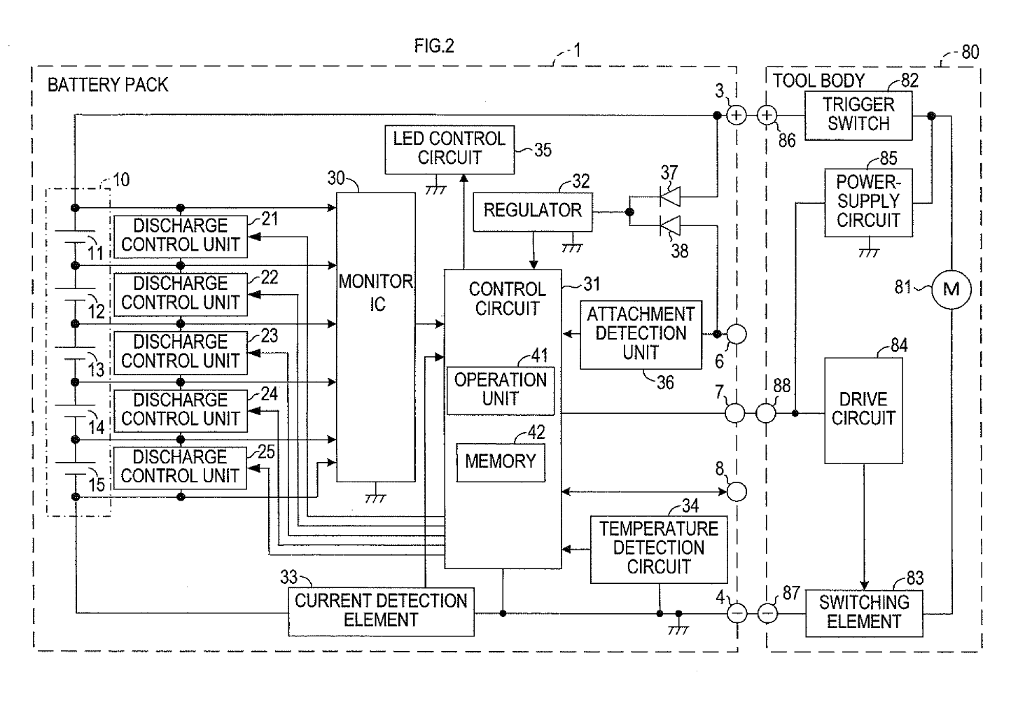

As shown in FIG. 1 and FIG. 2, a battery pack for a motor-driven appliance of the present embodiment (hereinafter abbreviated as a “battery pack”) 1 comprises a battery 10. The battery 10 is configured with a plurality of repeatedly chargeable and dischargeable cells connected in series to each other. In the battery 10 of the present embodiment, five cells 11, 12, 13, 14, and 15 are connected in series to each other. Each of the cells 11-15 of the present embodiment is a lithium-ion rechargeable battery cell, for example.

A casing of the battery pack 1 is configured to be able to be selectively attached to and detached from either a charger 60 or a tool body 80.

A positive electrode of the battery 10 is connected to a positive terminal 3, and a negative electrode of the battery 10 is connected to a negative terminal 4, When the battery pack 1 is attached to the charger 60, as shown in FIG. 1, the positive terminal 3 of the battery pack 1 is connected to a positive terminal 66 of the charger 60, and the negative terminal 4 of the battery pack 1 is connected to a negative terminal 67 of the charger 60. Due to such a configuration, charging of the battery 10 by the charger 60 can be performed.

When the battery pack 1 is attached to the tool body 80, as shown in FIG. 2, the positive terminal 3 of the battery pack 1 is connected to a positive terminal 86 of the tool body 80, and the negative terminal 4 of the battery pack 1 is connected to a negative terminal 87 of the tool body 80, Due to such a configuration, power feeding from the battery 10 to the tool body 80 (discharge of the battery 10, in other words) can be performed.

Connected to the battery 10 is a monitor IC 30 that monitors a state of the battery 10 and outputs the monitoring result to a control circuit 31. A main function of the monitor IC 30 is to detect a voltage (cell voltage) of each of the cells 11-15 and a voltage (battery voltage) of the battery 10 and to output the detection results to the control circuit 31. Both ends of each of the cells 11-15 are each connected to the monitor IC 30. The monitor IC 30 detects the voltage (i.e., cell voltage) of the both ends of each of the cells 11-15 and the battery voltage, and outputs a voltage detection signal corresponding to the detected respective cell voltages and battery voltage to the control circuit 31. In a case where the control circuit 31 has a function of calculating the battery voltage on the basis of the respective cell voltages, it is not always necessary for the monitor IC 30 to output the voltage detection signal indicating the battery voltage.

A timing of detection of the respective cell voltages and the battery voltage by the monitor IC 30 can be decided as appropriate. For example, the respective cell voltages and the battery voltage may be detected periodically, may be detected when a specified detection condition is met, or may be detected upon receipt of a detection instruction from the control circuit 31. A timing of output of the detection result (voltage detection signal) from the monitor IC 30 to the control circuit 31 also can be decided as appropriate. For example, the detection result may be outputted each time the respective cell voltages and the battery voltage are detected (i.e., may be outputted periodically), or may be outputted upon receipt of an output instruction from the control circuit 31. As long as the control circuit 31 can properly acquire the respective cell voltages and the battery voltage at an appropriate timing (e.g., acquire the latest possible values), the timing of detection by the monitor IC 30 and the timing of output of the detection result are not limited in particular.

In the present embodiment, in various processes performed by the control circuit 31, which are to be described later, various determination processes and calculation processes for the cell voltages are performed. The cell voltages used in such processes may be acquired from the monitor IC 30 each time the process is performed, or the latest values already acquired by a periodic acquisition, for example, may be used.

The respective cells 11-15 in the battery 10 are individually connected in parallel to discharge control units 21, 22, 23, 24, and 25, respectively. A discharge path for each cell is formed by each of the cells 11-15 and each of the discharge control units 21-25 corresponding thereto, respectively. Each of the discharge control units 21-25 includes a resistor that limits discharge current. In each of the cells 11-15, the both ends (a positive electrode and a negative electrode) are connected to each other via the resistor of the corresponding discharge control unit, to thereby form the discharge path leading from the positive electrode to the negative electrode via the resistor.

Each of the discharge control units 21-25 further includes a switch that closes and opens the corresponding discharge path. This switch is normally open, and thus, the discharge path is normally open. This switch is turned on and off in accordance with a discharge control signal individually outputted from the control circuit 31 to each of the discharge control units 21-25. When this switch is closed, the discharge path is closed and discharge of the corresponding cell is thereby performed. Specifically, in the corresponding cell, a current flows from the positive electrode to the negative electrode via the resistor and the switch, and power of the cell is thereby decreased. The discharge current at discharge can be adjusted by a resistance value of the resistor. Alternatively, a magnitude of the discharge current may be designed to be controllable by duty-driving the switch.

Due to the above-described configuration, each of the discharge control units 21-25 can discharge the corresponding cell at an approximately constant current. As a configuration of each of the discharge control units 21-25, the above-described configuration with the resistor and the switch is just an example.

Provided to a negative-side connection line connecting the negative electrode of the battery 10 and the negative terminal 4 to each other is a current detection element 33. The current detection element 33 is provided to detect a charging current from the charger 60 while the battery pack 1 is attached to the charger 60, and to detect the discharge current to the tool body 80 while the battery pack 1 is attached to the tool body 80. The current detection element 33 is connected to the control circuit 31. Specifically, a voltage between both ends of the current detection element 33 is directly inputted to the control circuit 31, or a signal indicating the voltage between the both ends is inputted to the control circuit 31 as a current detection signal.

The battery pack 1 further comprises a temperature detection circuit 34 that detects a temperature of the battery 10 (hereinafter referred to as a “battery temperature”) and outputs a temperature detection signal indicating the detection result. The temperature detection circuit 34 comprises a detection element (e.g., thermistor) that outputs a signal corresponding to the battery temperature and a signal processing circuit that processes the signal from the detection element to generate and output the temperature detection signal. The detection element is placed in the immediate vicinity of the battery 10 so that the battery temperature can be detected as accurately as possible.

The control circuit 31 comprises an operation unit 41 and a memory 42. The memory 42 includes a non-volatile memory (e.g., ROM), the storage content of which cannot be rewritten, a volatile memory (e.g., RAM), the storage content of which can be rewritten, and a non-volatile memory (e.g., flash memory), the storage content of which can be rewritten electrically. Mainly stored in the non-volatile memories in the memory 42 are various programs, data, and the like for fulfillment of various functions of the battery pack 1. Part of the various programs and the data may be stored in the flash memory.

The operation unit 41 executes the various programs stored in the memory 42 to thereby fulfill the various functions of the battery pack 1. A specific hardware configuration of the control circuit 31 can be conceived variously. In the present embodiment, the control circuit 31 is configured with a one-chip microcomputer mainly composed of a CPU, a ROM, and a RAM. Thus, the operation unit 41 is the CPU in the present embodiment. The volatile memory in the memory 42 is mainly used as a work area at the time when the operation unit 41 executes the various programs.

The control circuit 31 comprises an A/D converter (not shown) that converts inputted various analog signals into digital data. The current detection signal inputted from the current detection element 33, the voltage detection signal inputted from the monitor IC 30, and the temperature detection signal inputted from the temperature detection circuit 34 are A/D converted by the A/D converter, and the A/D converted signals are inputted to the operation unit 41. The operation unit 41 can detect the respective cell voltages, the battery voltage, the discharge current from the battery 10, the charging current to the battery 10, and the battery temperature, on the basis of the inputted A/D converted signals.

The battery pack 1 further comprises a Vcc input terminal 6, an AS output terminal 7, and a communication terminal 8. When the battery pack 1 is attached to the charger 60, the Vcc input terminal 6 of the battery pack 1 is connected to a Vcc output terminal 69 of the charger 60, and the communication terminal 8 of the battery pack 1 is connected to a communication terminal 68 of the charger 60. When the battery pack 1 is connected to the tool body 80, the AS output terminal 7 of the battery pack 1 is connected to an AS input terminal 88 of the tool body 80.

The battery pack 1 further comprises an attachment detection unit 36. The attachment detection unit 36 detects whether the battery pack 1 is attached to the charger 60, and outputs an attachment detection signal indicating the detection result to the control circuit 31. If a control voltage Vcc has been generated in the charger 60 when the battery pack 1 is attached to the charger 60, the control voltage Vcc is inputted from the charger 60 to the attachment detection unit 36 via the Vcc input terminal 6. If the control voltage Vcc has not been inputted, the attachment detection unit 36 outputs an attachment detection signal indicating that the battery pack 1 is not attached to the charger 60, and if the control voltage Vcc has been inputted, the attachment detection unit 36 outputs an attachment detection signal indicating that the battery pack 1 is attached to the charger 60. The control circuit 31 can recognize whether the battery pack 1 is attached to the charger 60 on the basis of the attachment detection signal inputted from the attachment detection unit 36.

The control circuit 31 has an abnormality detection function for detecting an abnormality of the battery pack 1. Specifically, whether an abnormality is occurring in the battery pack 1 is determined on the basis of the voltage detection signal inputted from the monitor IC 30, the temperature detection signal inputted from the temperature detection circuit 34, the current detection signal inputted from the current detection element 33, and the like. If an abnormality is determined to be occurring, an AS (abbreviation for auto stop) signal is outputted, and/or abnormality detection data indicating occurrence of the abnormality is outputted.

The AS signal is outputted when an abnormality occurs while discharge from the battery 10 to the tool body 80 is being performed after the battery pack 1 is attached to the tool body 80, and is inputted to the tool body 80 via the AS output terminal 7. On the other hand, the abnormality detection data is outputted while the battery pack 1 is attached to the charger 60, and is inputted to the charger 60 via the communication terminal 8. Besides, while the battery pack 1 is attached to the charger 60, the control circuit 31 can perform various data communications with the charger 60 via the communication terminal 8, as needed.

In the battery pack 1, an anode of a diode 38 is connected to the Vcc input terminal 6. A cathode of the diode 38 is connected to a regulator 32. Further, in the battery pack 1, an anode of a diode 37 is connected to the positive terminal 3. A cathode of the diode 37 is connected to the regulator 32. That is, the control voltage Vcc from the charger 60 can be inputted to the regulator 32 via the diode 38, and the battery voltage can be inputted to the regulator 32 via the diode 37.

While the battery pack 1 is attached to the charger 60, if the battery voltage is larger than the control voltage Vcc supplied from the charger 60, the regulator 32 is operated by receiving power supply from the battery 10, and generates a power-supply voltage. If the battery voltage is smaller than the control voltage Vcc supplied from the charger 60, the regulator 32 is operated by the control voltage Vcc supplied from the charger 60, and generates a power-supply voltage. If the battery voltage is equal to the control voltage Vcc supplied from the charger 60, the regulator 32 is operated by receiving power supply from both the battery 10 and the charger 60, and generates a power-supply voltage. The power-supply voltage generated by the regulator 32 is used as a power source for operating respective parts in the battery pack 1, including the control circuit 31 and the monitor IC 30.

The battery pack 1 further comprises a remaining power LED control circuit 35. More specifically, the remaining power LED control circuit 35 comprises a specified number (three, for example) of LEDs (not shown) and a control portion that controls current application to each of the LEDs (i.e., controls lighting and extinction of each of the LEDs). It is acceptable that the remaining power LED control circuit 35 is not provided.

The control circuit 31 calculates a remaining power of the battery 10 on the basis of the voltage detection signal inputted from the monitor IC 30, and outputs a remaining power signal corresponding to the calculated remaining power to the remaining power LED control circuit 35. The remaining power LED control circuit 35 lights and extinguishes each of the LEDs in a lighting pattern according to the remaining power indicated by the remaining power signal, on the basis of the remaining power signal inputted from the control circuit 31.

### (2) Configuration of Charger 60

As shown in FIG. 1, the charger 60 comprises a power-supply circuit 61, a charging control circuit 62, the positive terminal 66, the negative terminal 67, the communication terminal 68, and the Vcc output terminal 69.

In the present embodiment, the charging control circuit 62 is configured with a microcomputer similarly to the control circuit 31 in the battery pack 1, and is connected to the communication terminal 68. The communication terminal 68 is connected to the communication terminal 8 of the battery pack 1 when the battery pack 1 is attached to the charger 60, to thereby enable data communication between the charging control circuit 62 and the control circuit 31 in the battery pack 1.

The power-supply circuit 61 receives power supply from an external commercial power source (e.g., AC 100 V power source) or the like, and generates a charging power for charging the battery 10 in the battery pack 1. The charging power generated by the power-supply circuit 61 is supplied to the battery pack 1 via the positive terminal 66 and the negative terminal 67 while the battery pack 1 is attached to the charger 60.

The power-supply circuit 61 has a power-supply circuit for control contained therein that generates the control voltage Vcc. The control voltage Vcc generated by the power-supply circuit for control is used as a power-supply for operating the charging control circuit 62, and besides, is also supplied to the battery pack 1 via the Vcc output terminal 69 as already described.

When the charging power is supplied to the battery 10, the charging control circuit 62 acquires various data, such as the battery voltage and the charging current, from the control circuit 31 in the battery pack 1 through data communication, and performs charging control in accordance with the acquired various data.

### (3) Configuration of Tool Body 80

As shown in FIG. 2, when the battery pack 1 is attached to the tool body 80 and supply of electricity from the battery pack 1 is possible, the tool body 80 functions as a power tool together with the battery pack 1, as a whole. The tool body 80 comprises a motor 81, a trigger switch 82, a switching element 83, a drive circuit 84, a power-supply circuit 85, the positive terminal 86, the negative terminal 87, and the AS input terminal 88.

The positive terminal 86 is connected to one end of the motor 81 via the trigger switch 82. The negative terminal 87 is connected to the other end of the motor 81 via the switching element 83.

The trigger switch 82 is turned on and off by a user's operation of a not-shown trigger provided to the tool body 80. Specifically, when the user pulls the trigger, the trigger switch 82 is turned on, and when the user releases the trigger, the trigger switch 82 is turned off, Various kinds of information regarding the trigger switch 82, such as an on/off state of the trigger switch 82 and a pulled amount of the trigger, are inputted to the drive circuit 84.

The drive circuit 84 on/off-controls (duty-controls) the switching element 83 on the basis of the on/off state of the trigger switch 82, the pulled amount of the trigger, and the like, to thereby start current application (discharge) from the battery 10 to the motor 81. This causes the motor 81 to rotate at a rotational speed corresponding to the pulled amount of the trigger. When the motor 81 rotates, a not-shown tool element is operated by the rotary drive force of the motor 81, and the function as a power tool is thereby fulfilled. When the trigger switch 82 is turned off, the drive circuit 84 turns off the switching element 83, thereby to stop discharge from the battery pack 1 to the motor 81 and to stop the motor 81.

Furthermore, in a case where the AS signal is inputted from the battery pack 1 via the AS input terminal 88 while current application to the motor 81 is performed, the drive circuit 84 forcibly stops the current application to the motor 81.

### (4) Explanation of Balancing Control

Next, from among various control functions of the control circuit 31 in the battery pack 1, a detailed explanation will be given, especially, of a balancing control for reducing variation of the respective cell voltages. The balancing control is a control in which presence/absence of the cell that needs to be discharged is determined on the basis of the respective cell voltages and, if a cell that needs to be discharged is present, the cell is determined as a balancing target cell, and balancing (reduction of power by discharge, and eventually, decrease in cell voltage) of the cell is performed.

In the present embodiment, the determination of the balancing target cell in the balancing control is basically performed while discharge (supply of electricity) for driving the motor 81 from the battery 10 to the tool body 80 is being performed (hereinafter also referred to as “during load discharge”). Specifically, the respective cell voltages are monitored during load discharge, and in a case where the smallest cell voltage among the respective cell voltages becomes equal to or smaller than a threshold and also in a case where a cell is present whose voltage difference from the smallest cell voltage is equal to or larger than a defined value, such a cell is determined as a balancing target. Hereinafter, the cell determined to be balanced during load discharge is also referred to as an “under-load balancing target cell”.

However, in a case where the under-load balancing target cell is not determined during load discharge, when the battery pack 1 is attached to the charger 60, presence/absence of the balancing target cell is determined on the basis of the respective cell voltages (i.e., open voltages) at the time of such attachment.

Then, when the battery 10 is not used and shifts into a stable state, balancing of the balancing target cell is performed. Specifically, among the respective discharge control units 21-25, the discharge control unit corresponding to the balancing target cell is operated to discharge the balancing target cell, and the power of the balancing target cell is thereby reduced (and eventually, the cell voltage is decreased).

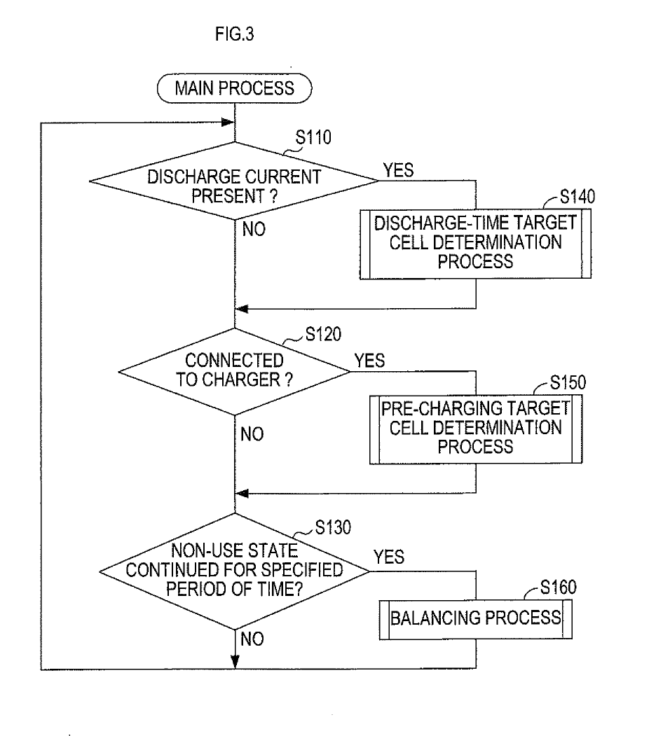

An explanation will be given of a main process performed by the control circuit 31 in the battery pack 1 in order to perform the above-described balancing control, with reference to FIG. 3. When the power-supply voltage is supplied from the regulator 32 to the control circuit 31 to thereby activate the control circuit 31 (activate the operation unit 41, specifically), the operation unit 41 reads a program for the main process in FIG. 3 from the memory 42 and executes the program.

When starting the main process in FIG. 3, the operation unit 41 in the control circuit 31 determines in S110 whether a discharge current is present, i.e., whether it is during load discharge. If no discharge current is present, i.e., discharge to the tool body 80 is not performed (S110: NO), the process proceeds to S120. If the discharge current is present, i.e., if it is during load discharge (S110: YES), a discharge-time target cell determination process is performed in S140. The discharge-time target cell determination process is a process for determining the under-load balancing target cell on the basis of the respective cell voltages during load discharge.

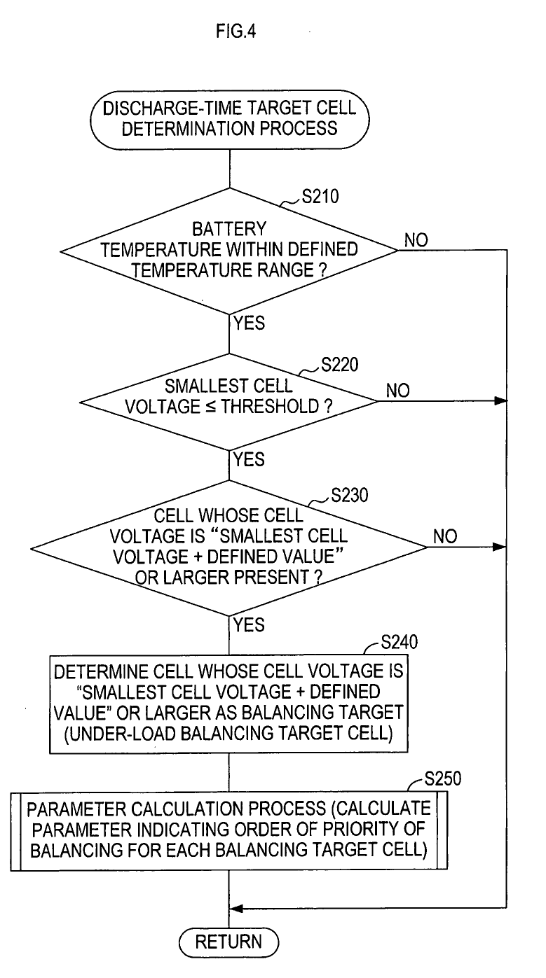

Details of the discharge-time target cell determination process of S140 are as shown in FIG. 4. When the process proceeds to the discharge-time target cell determination process, it is determined in S210 whether the battery temperature is within a defined temperature range. For example, a lower limit of the battery temperature is set in advance and, if the battery temperature is equal to or higher than the lower limit, the battery temperature can be determined to be within the defined temperature range. Alternatively, for example, a lower limit and an upper limit are set in advance and, if the battery temperature is equal to or higher than the lower limit and also equal to or lower than the upper limit, the battery temperature may be determined to be within the defined temperature range.

If the battery temperature is not within the defined temperature range (S210: NO), the discharge-time target cell determination process ends, and the process proceeds to S120 (FIG. 3). When the battery temperature is not within the defined temperature range, the balancing target cell may not be able to be determined appropriately. Especially, if the battery temperature is very low, internal impedance of the cell becomes very high. Thus, when it is during load discharge, the balancing target cell is designed to be determined when the battery temperature is within the defined temperature range.

If the battery temperature is within the defined temperature range (S210: YES), in S220, the respective cell voltages at present are acquired from the monitor IC 30 and it is determined whether the smallest cell voltage thereamong is equal to or smaller than a specified threshold. If the smallest cell voltage is larger than the threshold (S220: NO), the discharge-time target cell determination process ends, and the process proceeds to S120 (FIG. 3). Such a determination process of S220 is performed in order to determine presence/absence of the balancing target cell with reference to the cell voltage of the cell at the end stage of discharge. If the cell at the end stage of discharge is not present, the necessity of performing balancing is relatively low, and thus, balancing is designed not to be performed in the present embodiment. However, it is not essential not to perform balancing when the smallest cell voltage is larger than the threshold. Even when the smallest cell voltage is larger than the threshold, the balancing target cell may be determined and balancing may be performed as needed.

If the smallest cell voltage is equal to or smaller than the threshold (S220: YES), the process proceeds to S230. In S230, it is determined whether the cell having the cell voltage equal to or larger than “the smallest cell voltage+the defined value” is present among the respective cells 11-15. If the cell having the cell voltage equal to or larger than “the smallest cell voltage+the defined value” is not present (S230: NO), the discharge-time target cell determination process ends, and the process proceeds to S120 (FIG. 3). If the cell having the cell voltage equal to or larger than “the smallest cell voltage+the defined value” is present (S230: YES), the process proceeds to S240.

In S240, the cell having the cell voltage equal to or larger than “the smallest cell voltage+the defined value”, among the respective cells 11-15, is determined as the balancing target cell, and the determined cell is stored in the memory 42. Since the balancing target cell determined here is determined during load discharge, such a balancing target cell is the under-load balancing target cell.

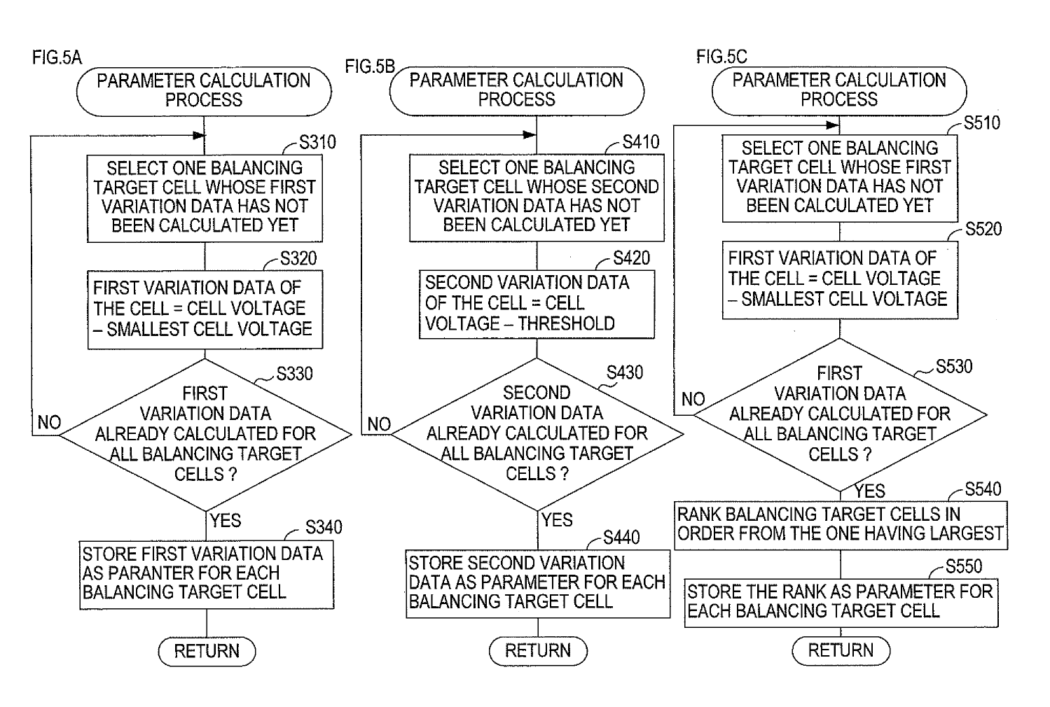

In S250, a parameter calculation process is performed, A parameter referred to here is a value calculated for each balancing target cell, and is a value indicating the order of priority of balancing. Details of the parameter calculation process of S250 are as shown in FIGS. 5A to 5C.

As shown in FIGS. 5A to 5C, in the present embodiment, there are three processing methods as the parameter calculation process, and any of the three processing methods can be adopted. The three parameter calculation processes will be explained in due order.

First, an explanation will be given of the parameter calculation process shown in FIG. 5A (hereinafter also referred to as a “first parameter calculation process”). When the process proceeds to the first parameter calculation process, in S310, one balancing target cell whose first variation data has not been calculated yet is selected from the balancing target cells determined in S240, It is to be noted that the first variation data refers to data to be calculated in S320.

In S320, for the balancing target cell selected in S310, the first variation data is calculated. Specifically, the first variation data of the balancing target cell is calculated by subtracting the smallest cell voltage from the cell voltage of the balancing target cell.

In S330, it is determined whether the first variation data has been already calculated for all of the balancing target cells. If any balancing target cell whose first variation data has not been calculated yet is present (S330: NO), the process returns to S310.

If the first variation data has been already calculated for all of the balancing target cells (S330: YES), the process proceeds to S340. In S340, for each balancing target cell, the first variation data of the balancing target cell is stored in the memory 42 as a parameter. That is, each parameter is stored in the memory 42 with the corresponding balancing target cell associated therewith. Processes of S440 and S550 to be described later are similar to such a process. When the process of S340 ends, the discharge-time target cell determination process in FIG. 4 ends, and thus, the process proceeds to S120 (FIG. 3).

Next, an explanation will be given of the parameter calculation process shown in FIG. 5B (hereinafter also referred to as a “second parameter calculation process”). When the process proceeds to the second parameter calculation process, in S410, one balancing target cell whose second variation data has not been calculated yet is selected from the balancing target cells determined in S240. It is to be noted that the second variation data refers to data to be calculated in S420.

In S420, for the balancing target cell selected in S410, the second variation data is calculated. Specifically, the second variation data of the balancing target cell is calculated by subtracting the threshold from the cell voltage of the balancing target cell. It is to be noted that the threshold used here is the same as that used in S220 (FIG. 4).

In S430, it is determined whether the second variation data has been already calculated for all of the balancing target cells. If any balancing target cell whose second variation data has not been calculated yet is present (S430: NO), the process returns to S410.

If the second variation data has been already calculated for all of the balancing target cells (S430: YES), the process proceeds to S440. In S440, for each balancing target cell, the second variation data of the balancing target cell is stored in the memory 42 as a parameter. When the process of S440 ends, the discharge-time target cell determination process in FIG. 4 ends, and thus, the process proceeds to S120 (FIG. 3).

Next, an explanation will be given of the parameter calculation process shown in FIG. 5C (hereinafter also referred to as a “third parameter calculation process”). In the third parameter calculation process, processes of S510-S530 are the same as those of S310-S330 in the first parameter calculation process, respectively, and thus, an explanation is not repeated here. In S540, the respective balancing target cells are ranked in order from the one having the largest first variation data. Specifically, the balancing target cells are ranked first, second, from the one having the largest first variation data (i.e., from the one having the largest difference from the smallest cell voltage).

In S550, for each balancing target cell, the above-described rank assigned to the balancing target cell is stored in the memory 42 as a parameter. When the process of S550 ends, the discharge-time target cell determination process in FIG. 4 ends, and thus, the process proceeds to S120 (FIG. 3).

In the present embodiment, which of the three parameter calculation processes shown in FIGS. 5A to 5C is to be adopted as the parameter calculation process of S250 is decided in advance, and the parameter of each balancing target cell (under-load balancing target cell) is calculated in the adopted parameter calculation process, and the calculated parameter is stored.

In S120, it is determined whether the charger 60 is in a state of attachment, i.e., whether the battery pack 1 has been connected to the charger 60 (but charging is not started yet). Such a determination is made on the basis of the attachment detection signal inputted from the attachment detection unit 36. Specifically, if the attachment detection signal indicating that the charger 60 is not attached is inputted from the attachment detection unit 36, it is determined that the battery pack 1 is not connected to the charger 60 (S120: NO), and the process proceeds to S130. If the attachment detection signal indicating that the charger 60 is in a state of attachment is inputted from the attachment detection unit 36, it is determined that the battery pack 1 is connected to the charger 60 (S120: YES), and a pre-charging target cell determination process is performed in S150. The pre-charging target cell determination process is a process for determining the balancing target cell on the basis of the respective cell voltages (open voltages) after connection of the charger 60 but before start of charging.

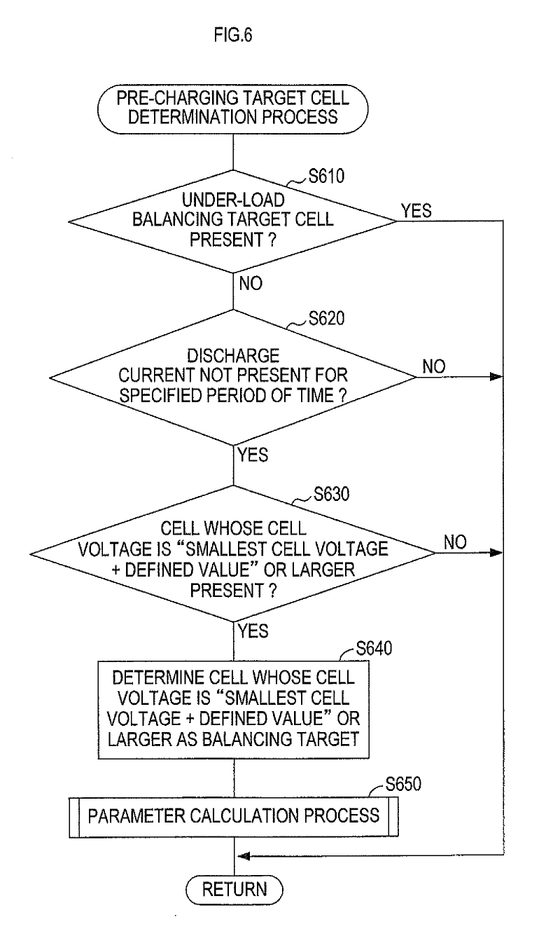

Details of the pre-charging target cell determination process of S150 are as shown in FIG. 6. When the process proceeds to the pre-charging target cell determination process, in S610, it is determined whether the under-load balancing target cell is present. If at least one under-load balancing target cell is present (S610: YES), the pre-charging target cell determination process ends, and the process proceeds to S130 (FIG. 3). That is, when at least one under-load balancing target cell is present, the determination of the balancing target cell on the basis of the open voltages before charging is not performed. In a case where no under-load balancing target cell is present, processes in or after S620 are performed, to thereby determine presence/absence of the balancing target cell on the basis of the open voltages.

Specifically, if no under-load balancing target cell is present (S610: NO), in S620, it is determined whether no discharge current is present for a specified period of time, i.e., whether a period during which discharge to the motor 81 is not performed has continued for the specified period of time or longer. If such a duration with no discharge current is shorter than the specified period of time (S620: NO), the pre-charging target cell determination process ends, and the process proceeds to S130 (FIG. 3). That is, in the case where the specified period of time has not elapsed yet since the stop of discharge, the respective cell voltages may not become stable yet, and thus, the various calculations based on the cell voltages are not performed. If the state in which no discharge current is present has continued for the specified period of time or longer (S620: YES), the process proceeds to S630.

In S630, the respective cell voltages at present are acquired from the monitor IC 30, and it is determined whether the cell having the cell voltage equal to or larger than “the smallest cell voltage+the defined value” is present among the respective cells 11-15. If no cell having the cell voltage equal to or larger than “the smallest cell voltage+the defined value” is present (S630: NO), the pre-charging target cell determination process ends, and the process proceeds to S130 (FIG. 3). If the cell having the cell voltage equal to or larger than “the smallest cell voltage+the defined value” is present (S630: YES), the process proceeds to S640.

In S640, the cell having the cell voltage equal to or larger than “the smallest cell voltage+the defined value”, among the respective cells 11-15, is determined as the balancing target cell, and the determined cell is stored in the memory 42. Then, the process proceeds to a parameter calculation process of S650. The parameter calculation process of S650 is identical to the parameter calculation process of S250 in the discharge-time target cell determination process, and the parameter calculation process decided to be adopted in advance among the three parameter calculation processes shown in FIGS. 5A to 5C is performed. After the parameter calculation process of S650 is performed, the process proceeds to S130 (FIG. 3).

As above, in the case where no under-load balancing target cell is present, presence/absence of the balancing target cell is determined on the basis of the open voltages before charging, and in the case where the balancing target cell is present, the parameter is calculated for each balancing target cell.

In S130, it is determined whether a state in which the battery pack 1 is not used has continued for a specified period of time. Specifically, such a determination can be made by determining whether a period during which neither discharge from the battery 10 to the tool body 80 nor charging of the battery 10 is performed and the control circuit 31 is in a standby state has continued for the specified period of time (e.g., one minute).

If the state in which the battery pack 1 is not used has not continued for the specified period of time yet (S130: NO), the process returns to S110. If the state in which the battery pack 1 is not used has continued for the specified period of time (S130: YES), a balancing process is performed in S160.

In short, the determination process of S130 is a process for determining whether the respective cell voltages are stable, and thus, the determination may be made using other methods as long as such a purpose of the process can be fulfilled.

Balancing of the battery 10 is performed in S160 when the affirmative determination is made in S130. In the balancing process of S160, the control circuit 31 goes into a sleep mode and stops operation as will be described later. Then, balancing is performed within the period of the sleep mode (however, periodical wake-up periods are included). That is, in the present embodiment, balancing is not performed while the control circuit 31 is performing a regular operation.

Thus, the determination process of S130 can also be considered to be a process for determining whether it is time to shift into a sleep mode in order to perform balancing during the sleep mode.

It is not essential not to perform balancing while the control circuit 31 is performing a regular operation, and balancing may be performed even while the control circuit 31 is performing a regular operation. That is, even while discharge to the tool body 80 is being performed or the battery 10 is being charged by the charger 60, for example, balancing may be performed. In the present embodiment, however, it is designed such that balancing is not performed while the control circuit 31 is performing a regular operation. A reason is that the respective cell voltages during balancing may be unstable and that, if various controls are performed on the basis of such unstable cell voltages, the control accuracy may be decreased. It is not impossible to detect the respective cell voltages with accuracy even during balancing. However, that requires adoption of the control circuit 31 or the monitor IC 30 that is expensive and of high quality, which is unrealistic in terms of costs.

The balancing process of S160 is mainly a process for balancing the balancing target cells one by one in order. The balancing performed here is an operation in which the discharge control unit corresponding to the balancing target cell is operated for a defined period of time to discharge the balancing target cell for the defined period of time, to thereby reduce the power of the balancing target cell (decrease the cell voltage).

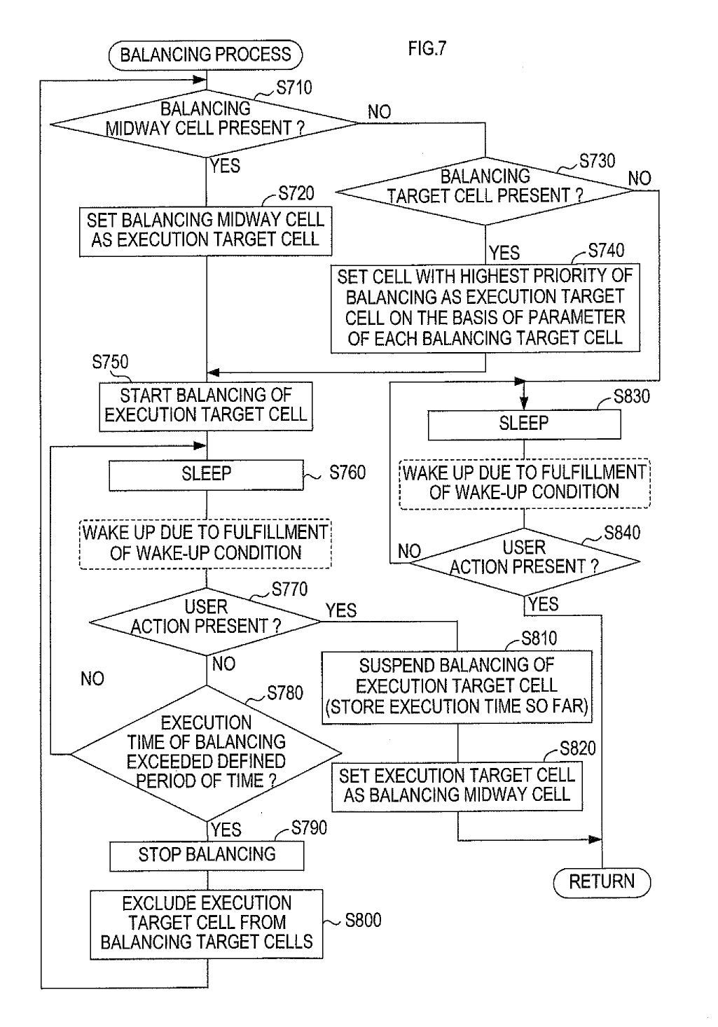

Details of the balancing process of S160 are as shown in FIG. 7. When the process proceeds to the balancing process, in S710, it is determined whether a balancing midway cell is present. The balancing midway cell refers to a cell the balancing of which was started but suspended in the process of S810. If the balancing midway cell is present (S710: YES), the balancing midway cell is set as an execution target cell in S720, and the process proceeds to S750. It is to be noted that, in S720, a process for reading, from the memory 42, an execution time indicating what extent of time the balancing of the balancing midway cell has already progressed at present is also performed. The execution time is stored in the memory 42 when the balancing is suspended in S810.

In S710, if no balancing midway cell is present (S710: NO), it is determined in S730 whether the balancing target cell is present. If no balancing target cell is present (S730: NO), the process proceeds to S830, and the control circuit 31 goes into a sleep mode. That is, only a predetermined minimum necessary function is maintained and operation of the other functions is stopped. The function to be maintained here includes at least a function of determining whether a wake-up condition is met that is a condition for canceling the sleep mode and causing the control circuit 31 to return to a regular operation. In the present embodiment, the control circuit 31 is configured to wake up periodically each time a specified period of time (e.g., 0.5 seconds) has elapsed. The control circuit 31 is also configured to wake up when the battery pack 1 is attached to the charger 60 and the control voltage Vcc is inputted. Furthermore, the control circuit 31 is also configured to wake up when the battery pack 1 is attached to the tool body 80 and the trigger switch 82 is turned on. After shifting to the sleep mode in S830, if any of these various wake-up conditions is met, the control circuit 31 returns to a regular operation from the sleep mode, and performs a process of S840.

In S840, it is determined whether a user action is present. The user action referred to here means at least the attachment to the charger 60 or the turning-on of the trigger switch 82 among the above-described various wake-up conditions. If no user action is present (S840: NO), that means that the control circuit 31 has woken up because the sleep mode has continued for the specified period of time. In this case, after performing a process predetermined as a process to be performed at wake-up, the control circuit 31 goes into a sleep mode again in S830. If the user action is present (S840: YES), the balancing process ends, and the process returns to S110 (FIG. 3).

In S730, if the balancing target cell is present (S730: YES), the process proceeds to S740. In S740, the order of priority of balancing is set on the basis of the parameter of each balancing target cell. Then, the cell with the highest priority is set as the execution target cell.

The present embodiment has three parameter calculation methods, as has been described above. In the case where the parameter calculation is performed by the first parameter calculation process shown in FIG. 5A, the first variation data is calculated as the parameter and stored. In this case, in S740, the order of priority is set in order from the largest first variation data. That is, the cell having the largest first variation data is ranked first in terms of priority. Then, the balancing target cell with the highest priority is set as the execution target cell.

In the case where the parameter calculation is performed by the second parameter calculation process shown in FIG. 5B, the second variation data is calculated as the parameter and stored. In this case, in S740, the order of priority is set in order from the largest second variation data. That is, the cell having the largest second variation data is ranked first in terms of priority. Then, the balancing target cell with the highest priority is set as the execution target cell.

In the case where the parameter calculation is performed by the third parameter calculation process shown in FIG. 5C, the rank of the first variation data is calculated as the parameter and stored. In this case, in S740, the rank of the first variation data is set as the order of priority as it is. That is, the cell having the largest first variation data is ranked first in terms of priority. Then, the balancing target cell with the highest priority is set as the execution target cell.

In S750, balancing of the execution target cell is started. Specifically, discharge of the execution target cell by the discharge control unit corresponding to the execution target cell is started. At this time, timekeeping of the execution time of the balancing is also started. However, in a case where the execution target cell is the balancing midway cell, timekeeping is restarted from the execution time read from the memory 42 at the process of S720. After the balancing is started in S750, the control circuit 31 goes into a sleep mode in S760 similarly to S830. The balancing (i.e., discharge) of the execution target cell is continued also during the sleep mode. That is, after instructing the discharge control unit corresponding to the execution target cell to perform balancing (discharge), the control circuit 31 itself goes into the sleep mode.

After shifting to the sleep mode, when the control circuit 31 wakes up due to fulfillment of the wake-up condition, the control circuit 31 determines in S770 whether the user action is present similarly to S840. If no user action is present (S770: NO), that means that the control circuit 31 has woken up because the sleep mode has continued for the specified period of time. In this case, the process predetermined as the process to be performed at wake-up is performed, and it is determined in S780 whether the execution time of the balancing has exceeded the defined period of time. If the execution time of the balancing has not exceeded the defined period of time (S780: NO), the process returns to S760.

If the execution time of the balancing has exceeded the defined period of time (S780: YES), the balancing of the execution target cell is stopped (i.e., discharge is stopped) in S790. Then, in S800, the execution target cell is excluded from the balancing target cells. That is, among the balancing target cells stored in the memory 42, the execution target cell (i.e., the cell the balancing of which for the defined period of time has been completed) is deleted from the memory 42. In this way, the number of the balancing target cells to be balanced stored in the memory 42 is reduced by one. After the process of S800, the process returns to S710.

In S770, if the user action is present (S770: YES), in S810, the balancing of the execution target cell under way is suspended. At this time, the execution time so far of the balancing of the execution target cell is stored in the memory 42. In S820, the execution target cell the balancing of which has been suspended in S810 is set as the balancing midway cell. After the process of S820, the process returns to S110 (FIG. 3).

### (5) Effects of Embodiment

According to the battery pack 1 of the present embodiment described above, the battery pack 1 is attached to the tool body 80 and the trigger switch 82 of the tool body 80 is turned on, and when discharge (supply of electricity) from the battery 10 to the motor 81 is performed, the respective cell voltages of the respective cells 11-15 are detected and the under-load balancing target cell is determined on the basis of the respective cell voltages. Each cell voltage detected during load discharge is a value with the internal impedance of the corresponding cell taken into account, Thus, an appropriate determination is made with the internal impedance of each of the cells 11-15 taken into account, and the under-load balancing target cell can be determined appropriately.

In the battery pack 1 of the present embodiment, the determination of the under-load balancing target cell based on the respective cell voltages during load discharge is performed when the battery temperature is within the defined temperature range. When the battery temperature is within the defined temperature range, the internal impedance of each of the cells 11-15 is also stable. Thus, the under-load balancing target cell can be determined more appropriately by detecting the respective cell voltages when the battery temperature is within the defined temperature range to thereby determine presence/absence of the balancing target cell.

In the battery pack 1 of the present embodiment, in the case where no under-load balancing target cell is determined during load discharge, the determination of presence/absence of the balancing target cell based on the open voltages of the respective cells 11-15 is performed. Then, as a result of the determination, if the cell to be balanced is present, the cell is determined as the balancing target cell, and balancing is performed.

That is, in the present embodiment, to detect the respective cell voltages during load discharge to thereby determine presence/absence of the under-load balancing target cell is fundamental, and if no under-load balancing target cell is present, presence/absence of the balancing target cell is determined on the basis of the open voltages of the respective cells 11-15. Thus, it is possible to determine the cell that needs to be balanced more appropriately.

In the battery pack 1 of the present embodiment, when the balancing target cell is determined, the parameter is calculated for each determined under-load balancing target cell, and the calculated parameter is stored in the memory 42. Then, balancing is performed for the balancing target cell stored in the memory 42. Thus, it is possible to reliably balance the cell that needs to be balanced just enough by referring to the storage content of the memory 42.

In the present embodiment, any of the first variation data, the second variation data, and the rank of the first variation data in descending order is calculated as the parameter. These parameters are all information that could be grounds for determining the order of priority of discharge. Thus, especially in the case where there is more than one balancing target cell, it is possible to determine appropriately and easily from which balancing target cell the balancing should be performed by storing the parameter for each balancing target cell, to thereby enable the balancing to be performed in an appropriate order.

When the first variation data or the second variation data is designed to be calculated as the parameter, the order of balancing can be determined in order from the cell having the largest data. In such a case, it is only necessary to perform a simple process, i.e., calculation and storage of either of the first variation data or the second variation data, and thus, it is possible to reduce the processing load of the balancing control borne by the control circuit 31, to thereby enable reduction of influence on other various processes performed by the control circuit 31.

On the other hand, when the ranking of the first variation data in descending order is designed to be calculated as the parameter, it is possible to perform the balancing according to the ranking, and thus, the order of balancing to be performed later can be determined more easily.

In the battery pack 1 of the present embodiment, the balancing of the balancing target cell is performed when charging of the battery 10 and discharge from the battery 10 to the tool body 80 have not been performed for the specified period of time set in advance. Thus, it is possible to inhibit the balancing control from affecting various regular processes performed by the control circuit 31, such as control of charging of the battery 10 and control of discharge to the tool body 80.

In the present embodiment, the respective discharge control units 21-25 correspond to one example of a cell discharge unit of the present invention. One example of a voltage detection unit of the present invention is configured with the monitor IC 30 and the operation unit 41. The operation unit 41 corresponds to one example of a target cell determination unit, a discharge control unit, and a no-load-time determination unit of the present invention. The memory 42 corresponds to one example of a storage unit of the present invention. The temperature detection circuit 34 corresponds to one example of a temperature detection unit of the present invention.

### OTHER EMBODIMENTS

Although the embodiment of the present invention has been explained above, the present invention is not limited to the above embodiment and can take various forms.

(1) In the above embodiment, as explained with reference to FIG. 4 and FIG. 6, the cell having the cell voltage equal to or larger than “the smallest cell voltage+the defined value” is determined as the balancing target cell. However, the method of determining the balancing target cell is not limited to this.

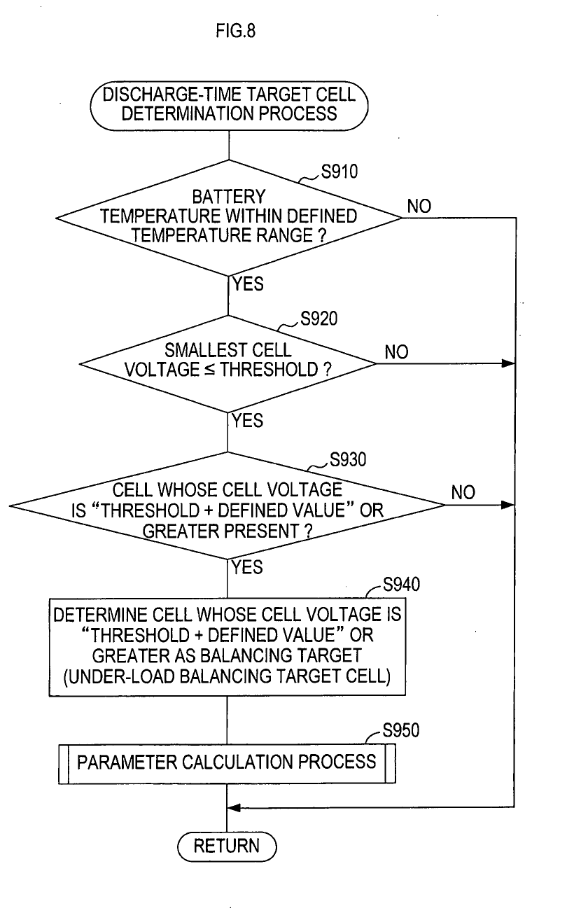

For example, the cell having a cell voltage equal to or larger than “the threshold+the defined value” may be determined as the balancing target cell. One example of the discharge-time target cell determination process configured to determine the cell having the cell voltage equal to or larger than “the threshold+the defined value” as the balancing target cell is shown in FIG. 8. In the discharge-time target cell determination process in FIG. 8, processes of S910-S920 are the same as those of S210-S220 in FIG. 4. In S930, it is determined whether the cell having the cell voltage equal to or larger than “the threshold+the defined value” is present among the respective cells 11-15. If no cell having the cell voltage equal to or larger than “the threshold+the defined value” is present (S930: NO), the discharge-time target cell determination process ends. If the cell having the cell voltage equal to or larger than “the threshold+the defined value” is present (S930: YES), the process proceeds to S940. In S940, among the respective cells 11-15, the cell having the cell voltage equal to or larger than “the threshold+the defined value” is determined as the balancing target cell (the under-load balancing target cell). Then, in S950, the parameter calculation process is performed similarly to S250 in FIG. 4.

Although not shown, also in the pre-charging target cell determination process in FIG. 6, the cell having the cell voltage equal to or larger than “the threshold+the defined value” may be determined as the balancing target cell.

Alternatively, for example, it may be possible to set a specified reference value that is smaller than the threshold and to determine the cell having a cell voltage equal to or larger than “the reference value+the defined value” as the balancing target cell. That is, as long as the difference from the smallest cell voltage is large enough to appropriately determine the cell whose difference should be narrowed, various methods can be adopted for such a determination.

(2) In the third parameter calculation process shown in FIG. 5C, the ranking is performed on the basis of the first variation data and the rank is used as the parameter. However, the ranking may be performed by other methods. For example, the ranking may be performed on the basis of the second variation data. That is, as long as the cell can be eventually ranked higher as the cell voltage thereof is more different from the smallest cell voltage, a specific method of ranking can be decided as appropriate.

(3) The parameter itself serving as a reference for determining the order of priority of balancing is not limited to the three parameters shown in FIGS. 5A to 5C, and other parameters may be used. That is, as long as the cell having the cell voltage more different from the smallest cell voltage is set as the execution target cell with higher priority in S740 in FIG. 7, what value is specifically to be used as the parameter can be decided as appropriate.

(4) In the case where the first variation data or the second variation data is calculated as the parameter, when the balancing target cell is balanced, a duration in which balancing is performed (i.e., discharge duration, and thus, discharge amount) may be set as appropriate for each balancing target cell according to the parameter.

(5) Depending on a use state of the battery pack 1, there is a possibility that the pre-charging target cell determination process is performed in a state in which the under-load balancing target cell still remains and the determination of the balancing target cell based on the open voltages is performed. That is, there is a possibility that the under-load balancing target cells and the balancing target cells based on the open voltages are present in a mixed manner. In such a case, it can be decided as appropriate in what order the balancing is to be performed. For example, priority may be absolutely placed on the balancing of the under-load balancing target cells. Specifically, it may be possible to complete balancing of all the under-load balancing target cells, and then to perform balancing of the balancing target cells based on the open voltages sequentially. Alternatively, for example, it may be possible to calculate the first variation data or the second variation data for all the balancing target cells present in a mixed manner, and then to balance them in order from the one having the largest calculation result.

Alternatively, in the first place, in the case where the under-load balancing target cells are determined in the discharge-time target cell determination process, it may possible not to perform the pre-charging target cell determination process until the balancing of all the determined under-load balancing target cells is completed. Furthermore, it may be possible also not to newly perform the discharge-time target cell determination process until the balancing of all the determined under-load balancing target cells is completed.

In contrast, in the case where the under-load balancing target cells are not determined in the discharge-time target cell determination process and the balancing target cells are thereby determined in the pre-charging target cell determination process, it may be possible not to perform the discharge-time target cell determination process until the balancing of all the determined balancing target cells is completed. Moreover, it may be possible also not to newly perform the pre-charging target cell determination process until the balancing of all the determined balancing target cells is completed. Furthermore, the pre-charging target cell determination process may be designed not to be performed. That is, in the main process in FIG. 3, it may be designed such that the processes of S120 and S150 are omitted and the process proceeds to S130 if a negative determination is made in S110 and after the process of S140 is performed.

(6) The battery pack 1 may comprise a remaining power indication switch for operating the remaining power LED control circuit 35 to indicate the remaining power of the battery 10. Specifically, it may be designed such that the remaining power is generally not indicated except a specified indication timing including a time when the remaining power indication switch is depressed, and that the remaining power is indicated at the specified indication timing, such as the time when the remaining power indication switch is depressed.

In such a case, it may be designed such that the depression of the remaining power indication switch is also set as one of the wake-up conditions for the control circuit 31, and that the control circuit 31 wakes up when the remaining power indication switch is depressed when the control circuit 31 is in a sleep mode. The depression of the remaining power indication switch may be included as the user action in S770 and S840 in FIG. 7.

(7) The respective cells 11-15 forming the battery 10 may be rechargeable battery cells other than the lithium-ion rechargeable battery cells.

In addition, the number of the series-connected respective cells forming the battery 10 is not limited to five as in the above embodiment. The battery 10 may be configured with a plurality of parallelly-connected blocks, each of which is configured with a plurality of cells connected in series to each other. Even when the battery 10 is configured as such, the balancing control can be performed for each block or for the battery 10 as a whole by applying the present invention.

(8) A motor-driven appliance to which the battery pack to which the present invention is applied is attachable is not limited to the tool body 80 of the above embodiment. The battery pack to which the present invention is applied can be attached to various motor-driven appliances driven by receiving power supply from the battery, such as a rechargeable driver drill, a rechargeable impact driver, a rechargeable impact wrench, a rechargeable grass cutter, a rechargeable grinder, a rechargeable circular saw, a rechargeable reciprocating saw.

(9) The present invention is not limited to application to the battery pack attachable to and detachable from the charger 60 and the tool body 80, like the battery pack 1 of the above embodiment. For example, the present invention can be applied to a power tool having a battery contained therein, i.e., to the contained battery.

(10) The function of one element in the above embodiment may be dispersed over a plurality of elements, or the functions of a plurality of elements may be integrated to one element. At least part of the configuration of the above embodiment may be replaced by a known configuration having a similar function. Part of the configuration of the above embodiment may be omitted. At least part of the configuration of the above embodiment may be added to or replace other configuration of the above embodiment. It is to be noted that any and all embodiments included in the technological thought specified solely by wordings in the claims are embodiments of the present invention.

What is claimed is:

1. A battery pack for a motor-driven appliance, the battery pack comprising:
a battery configured with a plurality of cells, which are chargeable and dischargeable, connected in series to each other;
a cell discharge unit configured to discharge each of the plurality of cells individually;
a voltage detection unit configured to detect a cell voltage, which is a voltage of each of the plurality of cells, when a driving power for a motor-driven appliance is supplied from the battery to the motor-driven appliance;
a target cell determination unit configured such that, when at least one cell, among the plurality of cells, having the cell voltage, detected by the voltage detection unit, equal to or smaller than a specified threshold is present, the cell voltage that is the smallest among the cell voltages equal to or smaller than the threshold is set as a smallest cell voltage, and when at least one other cell having the cell voltage larger than the smallest cell voltage by a defined value or more or having the cell voltage larger than the threshold by the defined value or more is present, the at least one other cell is determined as a target cell that should be discharged in order to reduce variation of the respective cell voltages; and
a discharge control unit configured to cause the cell determined as the target cell by the target cell determination unit to be discharged by the cell discharge unit.

2. The battery pack for a motor-driven appliance according to claim 1, comprising a temperature detection unit that detects a temperature of the battery,
wherein the voltage detection unit is configured to detect the cell voltage of each of the plurality of cells when the temperature of the battery detected by the temperature detection unit is within a defined temperature range.

3. The battery pack for a motor-driven appliance according to claim 1, comprising a storage unit in which information is storable,
wherein, when at least one cell determined as the target cell is present, the target cell determination unit stores the at least one target cell in the storage unit, and
wherein the discharge control unit causes the at least one target cell stored in the storage unit to be discharged by the cell discharge unit.

4. The battery pack for a motor-driven appliance according to claim 3,
wherein, when at least one cell determined as the target cell is present, the target cell determination unit calculates a parameter indicating an order of priority of discharge to be performed by the discharge control unit for each target cell, and stores the parameter in the storage unit for each target cell.

5. The battery pack for a motor-driven appliance according to claim 4,
wherein the target cell determination unit calculates, as the parameter for each target cell, a first variation data indicating a value obtained by subtracting the smallest cell voltage from the cell voltage of the target cell, or a second variation data indicating a value obtained by subtracting the threshold from the cell voltage of the target cell, and stores the first variation data or the second variation data in the storage unit.

6. The battery pack for a motor-driven appliance according to claim 4,
wherein the target cell determination unit calculates, as the parameter for each target cell, a rank, in descending order, of the value obtained by subtracting the smallest cell voltage from the cell voltage of the target cell, or a rank, in descending order, of the value obtained by subtracting the threshold from the cell voltage of the target cell, and stores the calculated rank in the storage unit.

7. The battery pack for a motor-driven appliance according to claim 1,
wherein the discharge control unit causes the target cell to be discharged by the cell discharge unit when the battery has not been charged for a specified period of time set in advance or longer and also supply of the driving power to the motor-driven appliance has not been performed for the specified period of time or longer.

8. The battery pack for a motor-driven appliance according to claim 1, comprising a no-load-time determination unit configured such that, when no target cell is determined as a result of determination by the target cell determination unit, the respective cell voltages are detected at a specified determination timing during a period in which supply of the driving power from the battery to the motor-driven appliance is not performed, and it is determined whether the cell to be discharged in order to reduce variation of the respective cell voltages is present on the basis of the detected respective cell voltages,
wherein the discharge control unit is configured, when it is determined that the cell to be discharged is present by the no-load-time determination unit, to cause the cell to be discharged as the target cell by the cell discharge unit.
